(19) United States
(12) Patent Application Publication
(10) Pub. No.: US 2021/0312502 A1
(43) Pub. Date: Oct. 7, 2021

(54) SYSTEM AND METHOD FOR GENERATING CUSTOMIZED ADVERTISEMENT

(71) Applicant: Capital One Services, LLC, McLean, VA (US)

(72) Inventors: Jeremy GOODSITT, Champaign, IL (US); Reza FARIVAR, Champaign, IL (US); Vincent PHAM, Champaign, IL (US); Mark WATSON, Sedona, AR (US); Farid Abdi Taghi ABAD, Seattle, WA (US); Austin WALTERS, Savoy, IL (US)

(73) Assignee: Capital One Services, LLC, McLean, VA (US)

(21) Appl. No.: 16/837,725

(22) Filed: Apr. 1, 2020

(51) Int. Cl. G06Q 30/02; G06N 20/00

(52) U.S. Cl. CPC G06Q 30/0269; G06Q 30/0276; G06N 20/00; G06Q 30/0277; G06Q 30/0255

(57) ABSTRACT

A system for customizing an advertisement to be displayed on a web page accessed by a user, includes one or more processors configured to execute the instructions to detect that the user has accessed the web page that includes the to-be-displayed advertisement; retrieve, from the database, an advertisement template for the advertisement in response to detection that the user has accessed the web page; extract a stylistic preference of the user from the database, wherein the stylistic preference is an advertisement visual characteristic that corresponds to user preference based on prior interaction of the user with one or more online advertisements; modify a visual characteristic of the advertisement template based on the extracted stylistic preference to generate a customized advertisement; and provide the customized advertisement for display to the user.

### TECHNICAL FIELD

Embodiments of the present disclosure relate to systems and methods for generating a customized advertisement for a user. More particularly, embodiments of the present disclosure relate to using user feedback to determine a stylistic preference of the user for use in generating the customized advertisement.

### BACKGROUND

Online and mobile advertising are becoming increasingly prevalent and highly targeted. Advertising may take the form of promotional marketing messages, electronic coupons or offers, political statements, social communications, and various other types of messages sent to user devices (e.g., mobile devices, wearables, desktop computers, etc.). Selecting and configuring advertisements and other creatives to display on webpages is necessary for advertisers to maximize their revenue, viewership, and other desirable interactions. Historically, online advertisers have relied on visitor demographics, previous purchase history, product selection, and other criteria to inform their advertising decisions. Specifically, online advertisers provide targeted advertisements to a particular user based on user information collected and stored by the user's web browser. These advertisers can determine specific information about a user, such as the user's age, location, etc. Then, based on such information, the online advertiser may provide a targeted advertisement to the user. Currently, however, the provided advertisements have to be pre-created. Further, once they are created, there is currently no means of modifying the advertisements after user preference information is determined.

### SUMMARY

In accordance with embodiments of the present disclosure, there is provided a system for customizing an advertisement to be displayed on a web page accessed by a user, the system comprising: one or more memory devices storing instructions; and one or more processors in communication with a database configured to execute the instructions to: detect that the user has accessed the web page that includes the to-be-displayed advertisement; retrieve, from the database, an advertisement template for the advertisement in response to detection that the user has accessed the web page; extract a stylistic preference of the user from the database, wherein the stylistic preference is an advertisement visual characteristic that corresponds to user preference based on prior interaction of the user with one or more online advertisements; modify a visual characteristic of the advertisement template based on the extracted stylistic preference to generate a customized advertisement; and provide the customized advertisement for display to the user.

In accordance with embodiments of the present disclosure, there is also provided a computer implemented method for customizing an advertisement to be displayed on a web page accessed by a user, the method comprising: detecting that the user has accessed the web page that includes the to-be-displayed advertisement; retrieving from a database, an advertisement template for the advertisement in response to detection that the user has accessed the web page; extracting a stylistic preference of the user from the database, wherein the stylistic preference is an advertisement visual characteristic that corresponds to user preference based on prior interaction of the user with one or more online advertisements; modifying a visual characteristic of the advertisement template based on the extracted stylistic preference to generate a customized advertisement; and providing the customized advertisement for display to the user.

In accordance with embodiments of the present disclosure, there is further provided a non-transitory computer-readable medium storing instructions executable by one or more processors to perform operations for customizing an advertisement to be displayed on a web page accessed by a user, the operations comprising: detecting that the user has accessed the web page that includes the to-be-displayed advertisement; retrieving from a database, an advertisement template for the advertisement in response to detection that the user has accessed the web page; extracting a stylistic preference of the user from the database, wherein the stylistic preference is an advertisement visual characteristic that corresponds to user preference based on prior interaction of the user with one or more online advertisements; modifying a visual characteristic of the advertisement template based on the extracted stylistic preference to generate a customized advertisement; and providing the customized advertisement for display to the user.

### BRIEF DESCRIPTION OF DRAWINGS

The accompanying drawings, which are incorporated in and constitute a part of this specification, illustrate disclosed embodiments and, together with the description, serve to explain the disclosed embodiments. In the drawings:

FIG. 1 is a block diagram of an exemplary system, consistent with disclosed embodiments.

FIG. 2 is a flowchart of an exemplary process, consistent with disclosed embodiments.

FIG. 3 is a flowchart of an exemplary process, consistent with disclosed embodiments.

FIG. 4 is a flowchart of an exemplary process, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting.

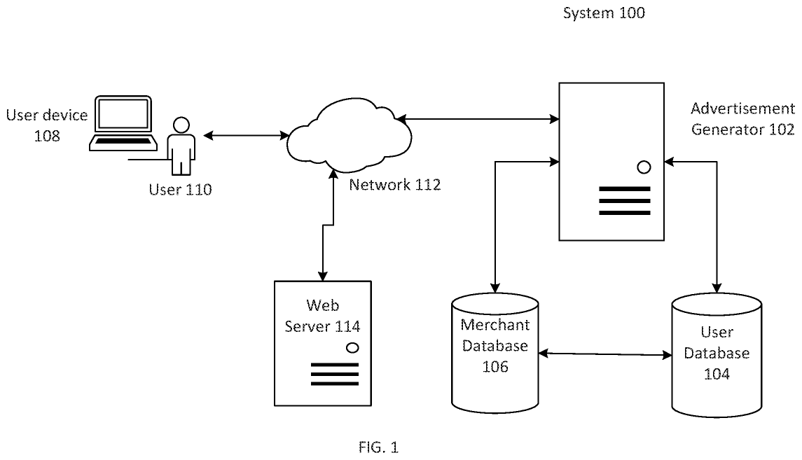

FIG. 1 is a block diagram of an exemplary system 100, for performing one or more operations consistent with disclosed embodiments. In some embodiments, system 100 includes one or more advertisement generators 102, one or more user databases 104, one or more merchant databases 106, one or more user devices 108, a network 112, and one or more web servers 114. The components and arrangement of the components included in system 100 may vary. Thus, system 100 may include other components that perform or assist in the performance of one or more processes consistent with the disclosed embodiments.

Components of system 100 may include one or more computing devices (e.g., computer(s), server(s), etc.), memory storing data and/or software instructions (e.g., database(s), memory devices, etc.), and other known computing components. In some embodiments, the one or more computing devices may be configured to execute software instructions stored on one or more memory devices to perform one or more operations consistent with the disclosed embodiments. Aspects of advertisement generator(s) 102, one or more user database(s) 104, one or more merchant database(s) 106, one or more user device(s) 108, one or more web server(s) 114 may be configured to communicate with one or more other components of system 100, via network 112, for example. In certain aspects, a user 110 is associated with and operates user device 108 to interact with one or more components of system 100 to send and receive communications, initiate operations, and/or provide input for one or more operations consistent with the disclosed embodiments.

Components of system 100 may be configured to detect when user 110 has accessed a web page that includes a to-be-displayed advertisement and provide a personalized advertisement to user 110, based on stylistic preference of user 110. In one embodiment, user device 108 is configured to request and receive information from network 112. The information may include web pages with advertisements. User device 108 may be configured to access other data/information in addition to web pages over network 112 using a web browser, such as Internet Explorer®, Firefox®, or Chrome®. In another embodiment, software programs other than web browsers may also display advertisements received over the network 112 or from a different source. As described below, the advertisements are displayed in a web page and user feedback is used for personalizing the to-be-displayed advertisement.

In one embodiment, web server 114 provides an interface to network 112 and/or provides its web pages over network 112, such as to user device 108. Web server 114 may provide user device 108 with web pages (including advertisements) that are requested over network 112, such as by user 110, associated with user device 108. In particular, web server 114 may provide a web page, or a series of web pages when requested by user device 108. For example, the web page may be a news organization, such as ABC® that provides pages and sites associated with www.abcnews.com. Accordingly, when user device 108 requests a web page from www.abcnews.com, that web page is provide over network 112 by web server 114. That web page may include advertising space or advertisement slots that are filled with advertisements to be viewed with the web page.

In some embodiments, advertisement generator 102 may detect that user 110 has accessed a web page that includes the to-be-displayed advertisement. Advertisement generator 102 may include a processor configured to generate a personalized advertisement for user 110. Advertisement generator 102 may be configured to extract an advertisement template from merchant database 106 based on the accessed web page. Advertisement generator 102 may further be configured to query and extract one or more stylistic preferences of user 110 from user database 104.

User database 104 of system 100, may be communicatively coupled to advertisement generator 102 and merchant database 106. User database 104 and merchant database 106 may include one or more memory devices that store information and are accessed and/or managed by one or more components of system 100. By way of example, user database 104 and merchant database 106 may each include Oracle™ databases, Sybase™ databases, or other relational databases or nonrelational databases, such as Hadoop sequence files, HBase, or Cassandra. User database 104 and merchant database 106 may each include computing components (e.g., database management system, database server, etc.) configured to receive and process requests for data stored in memory devices of user database 104 and merchant database 106 and to provide data.

In some embodiments, user database 104 is configured to store the stylistic preferences of user 110, i.e., comprehensive features, exclusive features and general features of advertisements user 110 has interacted with, as more fully described below. In some embodiments, merchant database 106 is configured to store merchant data. Merchant data may include advertisement templates for different products from multiple merchants to be displayed on multiple landing sites. Advertisement generator 102 may periodically update merchant database 106 to include new templets of advertisements to be displayed to user 110.

In one aspect, advertisement generator 102 may include one or more computing devices, configured to perform one or more operations consistent with disclosed embodiments. In one aspect, advertisement generator 102 may include one or more servers or server systems. Advertisement generator 102 may include one or more processors configured to execute software instructions stored in a memory or other storage device. The one or more processors may be configured to execute software instructions that, when executed by a processor, perform internet-related communication and machine learning for advertisement personalization. Advertisement generator 102 may be a computing system configured to collect, store, and analyze stylistic preferences of user 110. For example, advertisement generator 102 may be a server configured to communicate with other components of system 100 to receive and provide stylistic preferences of user 110. Advertisement generator 102 may execute software that uses the stylistic preferences of user 110 and advertisement templates stored in merchant database 106 to customize and display advertisements, on a display device included in, or connected to, user device 108.

Advertisement generator 102, user database 104, merchant database 106, web server 114, and user device 108 may be configured to communicate with each other over network 112. Network 112 may comprise any type of computer networking arrangement configured to provide communications or exchange data, or both, between components of system 100. For example, network 112 may include any type of network (including infrastructure) that provides communications, exchanges information, and/or facilitates the exchange of information, such as the Internet, a private data network, a virtual private network using a public network, a LAN or WAN network, a Wi-Fi™ network, and/or other suitable connections that may enable information exchange among various components of system 100. Network 112 may also include a public switched telephone network (“PSTN”) and/or a wireless cellular network. Network 112 may be a secured network or unsecured network. In some embodiments, one or more components of system 100 may communicate directly through a dedicated communication link(s).

User device 108 may be one or more computing devices configured to perform one or more operations consistent with the disclosed embodiments. User device 108 may execute browser or related mobile display software that displays web pages with advertisements, on a display included in, or connected to, user device 108. For example, user device 108 may be a smartphone, a laptop or notebook computer, a tablet, a multifunctional watch, a pair of multifunctional glasses, or any mobile or wearable device with computing ability, or any combination of these computers and/or affiliated components. User device 108 is configured to allow user 110 to interact with advertisements using various input/output devices, such as a keyboard, a mouse-type device, a gesture sensor, an action sensor, a physical button, switch, microphone, touchscreen panel, stylus, etc., that may be manipulated by user 110 to input information using user device 108. I/O devices may also include an audio output device, such as a speaker configured to provide sound and audio feedback to user 110 operating user device 108. I/O devices may also include a transceiver or transmitter configured to communicate using one or more wireless technologies/protocols that may include, without limitation, cellular (e.g., 3G, 4G, etc.) technology, Wi-Fi™ hotspot technology, RFID, near-field communication (NFC) or BLUETOOTH® technologies, etc. More generally, any uni- or bi-directional communication technology known to one of ordinary skill in the art may be implemented in user device 108 to exchange information with advertisement generator 102, user database 104, merchant database 106, and web server 114, over network 112.

It is to be understood that the configuration of the functional blocks of system 100 has been defined herein for convenience of description. The components and arrangement of the components included in system 100 may vary. For example, in some embodiments, system 100 may include other components that perform or assist in the performance of one or more processes consistent with disclosed methods. System 100 includes a number of components generally described as computing devices. Each of the computing devices may include any number of computing components particularly configured as a special purpose computing device to perform the functionality disclosed herein. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

An initial overview of machine learning and prediction model generation is first provided immediately below and then specific exemplary embodiments of systems, methods, and devices for generating a personalized advertisement for user 110 are described in further detail. The initial overview is intended to aid in understanding some of the technology relevant to the systems, methods, and devices disclosed herein, but it is not intended to limit the scope of the claimed subject matter.

In the world of machine prediction, there are two subfields knowledge-based systems and machine-learning systems. Knowledge-based approaches rely on the creation of a heuristic or rule-base which is then systematically applied to a particular problem or dataset. Knowledge-based systems make inferences or decisions based on an explicit “if-then” rule system. Such systems rely on extracting a high degree of knowledge about a limited category to virtually render all possible solutions to a given problem. These solutions are then written as a series of instructions to be sequentially followed by a machine.

Machine learning systems, unlike the knowledge-based systems, provide machines with the ability to learn through data input without being explicitly programmed with rules. For example, as just discussed, conventional knowledge-based programming relies on manually writing algorithms (i.e., rules) and programming instructions to sequentially execute the algorithms. Machine learning systems, on the other hand, avoid following strict sequential programming instructions by making data-driven decisions to construct their own rules. The nature of machine learning is the iterative process of using rules, and creating new ones, to identify unknown relationships to better generalize and handle non-linear problems with incomplete input data sets. A detailed explanation of one such machine learning technique is disclosed in the article: Michalski, R. S., Stepp, R. E. “Learning from Observation: Conceptual Clustering,” Chapter 11 of Machine Learning: An Artificial Intelligence Approach, eds. R. S. Michalski, J. G. Carbonell and T. M. Mitchell, San Mateo: Morgan Kaufmann, 1983. Embodiments of the present disclosure implement a prediction model which uses machine learning.

In some embodiments, advertisement generator 102 uses a machine learning model to generate stylistic preferences of user 110 which may increase a probability that user 110 will interact with an advertisement. In some embodiments, the machine learning model may be designed for new advertisements for which there is no historical interaction information. In other embodiments, the machine learning model may incorporate historical interaction data for related or similar advertisements. For example, stylistic preferences of user 110 may be extracted from an advertisement with which user 110 interacted in the past. The machine learning model may use the user interaction with the advertisement as positive feedback to learn stylistic preferences of user 110. In some embodiments, feedback provided by user 110 may be in any form, including acoustic, speech, or tactile input. For example, user 110 may be able to provide feedback by clicking on the advertisement, playing a video or audio file embedded within the advertisement, or providing an audio command to display the advertisement.

In some embodiments, stylistic preferences of user 110 may be defined as visual characteristics of advertisements that correspond to preferences of user 110 based on prior interaction of user 110 with one or more online advertisements. Stylistic preferences of user 110 may include, at least, one or more of font style, font size, image size, shape, dominant color, spacing, placement, or color combination, as well as other stylistic elements of advertisements. Stylistic preferences may be divided into three categories: comprehensive preferences, exclusive preferences, and general preferences.

In some embodiments, comprehensive features may be utilized to describe the overall aesthetic of an advertisement on a web page. Comprehensive features may include spatial arrangement of the advertisement on the web page. For example, some users may be more likely to interact with an advertisement if it is displayed on the top right corner of the web page and other users may be more likely to interact with the advertisement if it is displayed on the bottom right corner of the web page. Comprehensive features may also include size of an advertisement on a web page. For example, some users may be more likely to interact with the advertisement if covers less than 25% of the web page and other users may be more likely to interact with the advertisement if it covers more than 25% of the web page of the web page. Comprehensive features may also include the amount of textual and pictorial representation within an advertisement. For example, some users may be more likely to interact with the advertisement if it includes more images than text and other users may be more likely to interact with the advertisement if it includes more text than images.

In some embodiments, exclusive features may be utilized to describe specific aesthetics of an advertisement on a web page. Exclusive features may include colors, grayscale, fonts, font colors, font sizes, shapes, scenes, etc. preferred by user 110. For example, some users may be more likely to interact with the advertisement if it prominently displays products in the color red, while other users may be more likely to interact with the advertisement if it prominently displays Arial italic font in the color blue.

In some embodiments, general features may be utilized to describe if user 110 prefers multimedia features, flash features, audio features, still images, soundless advertisements, etc. For example, some users may be more likely to interact with an advertisement if it is an audio-visual representation of products, while other users may be more likely to interact with an advertisement if it is a soundless advertisement.

In some embodiments, the machine learning model communicatively coupled to or included within advertisement generator 102, is constructed using the stylistic preferences of user 110. The machine learning model iteratively updates its algorithm with the stylistic preferences of user 110 based on interactions of user 110 with advertisements. For example, when user 110 interacts with an advertisement, advertisement generator 102 stores in user database 104, the stylistic preferences of user 110, i.e. comprehensive features, exclusive features and general features of the advertisement with which user 110 has interacted with in user database 104. In some embodiments, advertisement generator 102 may be configured to apply the stored stylistic preferences of user 110 to an advertisement template to generate the personalized advertisement based on stylistic preferences of user 110.

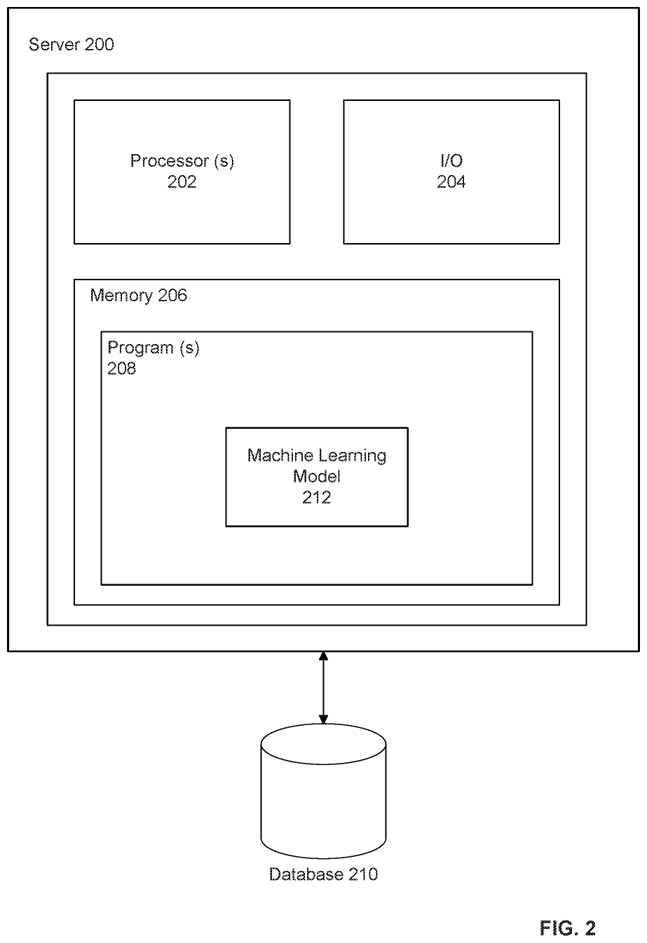

FIG. 2 shows an exemplary device 200 consistent with the disclosed embodiments. Variations of exemplary device 200 may constitute one or more components of advertisement generator 102, web server 114, and/or user device 108. In one embodiment, device 200 includes one or more processors 202, one or more input/output (I/O) devices 204, and one or more memories 206. In some embodiments, device 200 may be a part of advertisement generator 102. In some embodiments, device 200 may take the form of a specially programmed server or computing system used by advertisement generator 102. In some embodiments, device 200 may be configured as an apparatus, embedded system, dedicated circuit, and the like based on the storage, execution, and/or implementation of the software instructions that perform one or more operations consistent with the disclosed embodiments.

Processor 202 may include one or more known processing devices, such as a microprocessor from the Pentium™ or Xeon™ family manufactured by Intel™, or the Turion™ family manufactured by AMD™, for example. The disclosed embodiments are not limited to any type of processor(s) otherwise configured to meet the computing demands required of different components of system 100.

Memory 206 may include one or more storage devices configured to store instructions used by processor 202 to perform functions related to disclosed embodiments. For example, memory 206 may be configured with one or more software instructions, such as program(s) 208 that may perform one or more operations when executed by processor 202. The disclosed embodiments are not limited to separate programs or computers configured to perform dedicated tasks. For example, memory 206 may include a single program 208 that performs the functions of advertisement generator 102, web server 114, and/or user device 108, or program 208 may comprise multiple programs. In certain embodiments, memory 206 may store sets of instructions or programs 208 for extracting a stylistic preference of the user from the database, modifying a visual characteristic of the advertisement template based on one or more extracted stylistic preferences to generate a customized advertisement, and providing the customized advertisement for display to user 110. These sets of instructions may be executed by processor 202 to perform communication and/or processes consistent with disclosed embodiments.

In certain embodiments, when device 200 constitutes one or more of the components of advertisement generator 102, memory 206 includes a machine learning model 212, corresponding to the above-described machine learning model, for modifying a visual characteristic of the advertisement template based on one or more extracted stylistic preferences to generate a customized advertisement. Machine learning model 212 may employ various machine learning techniques including decision tree learning, association rule learning, artificial neural networks, inductive logic programming, support vector machines, clustering, Bayesian networking, reinforcement learning, representation learning, similarity and metric learning, spare dictionary learning, rule-based machine learning, etc.

Device 200 may also be communicatively coupled to one or more of user database(s) 104 and merchant database(s) 106. In one aspect, device 200 may include a database 210. Alternatively, database 210 may be located remotely from device 200 and device 200 may be communicatively coupled to database(s) 210 through network 112.

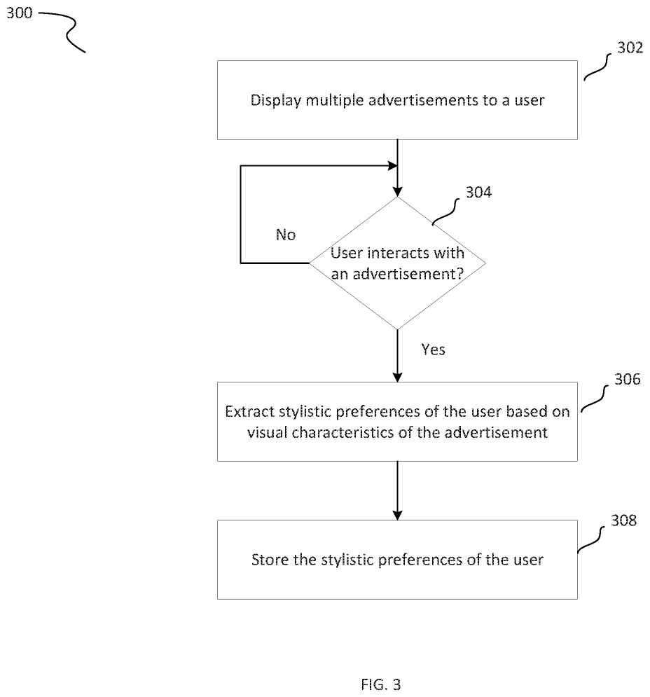

FIG. 3 is a flowchart of an exemplary process 300 to capture and store stylistic preferences of user 110 based on visual characteristics of an advertisement, consistent with the disclosed embodiments. In certain aspects, advertisement generator 102 may be configured to execute software instructions that perform one or more of the operations of process 300.

In accordance with process 300, advertisement generator 102 displays multiple advertisements to user 110 (Step 302). In some embodiments, multiple advertisements may be displayed to user 110 at the same time. In some embodiments, multiple advertisements may be displayed to user 110 over a period of time. In some embodiments, multiple advertisements may be displayed to user 110 on multiple web pages. In some embodiments, multiple advertisements may be displayed to user 110 on a single web page.

When user 110 does not interact with an advertisement (Step 304—NO), advertisement generator 102 assigns negative values to corresponding visual characteristics of the advertisement. Advertisement generator 102 stores these visual characteristics with their corresponding negative values in user database 104. When user 110 interacts with an advertisement (Step 304—YES), advertisement generator 102 assigns positive values to corresponding visual characteristics of the advertisement. The visual characteristics with their corresponding positive values are extracted and stored as stylistic preferences of user 110 (Step 306). Advertisement generator 102 then segregates these stylistic preferences as comprehensive features, exclusive features, and general features and stores them in user database 104 (Step 308). In some embodiments, the stylistic preferences of user 110 extracted in accordance with process 300 are used by machine learning model 212 to refine the stylistic preferences of user 110 over a period of time.

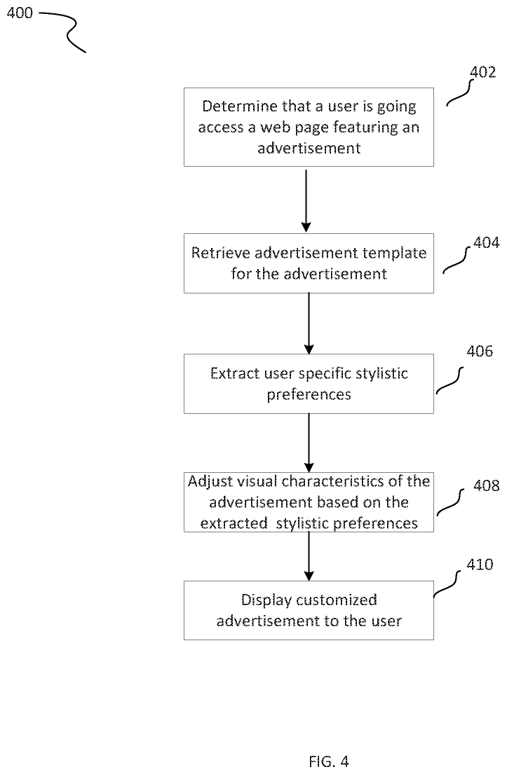

FIG. 4 is a flowchart of an exemplary process 400 to generate and display a customized advertisement to a user, consistent with the disclosed embodiments. In certain aspects, advertisement generator 102 may be configured to execute software instructions that perform one or more of the operations of process 400.

In accordance with process 400, user 110 accesses a web page. User 110 may operate user device 108 to execute browser or related mobile display software that displays web pages with advertisements, on a display included in, or connected to, user device 108. Upon detecting that user 110 wants to access a web-page, advertisement generator 102 determines whether an advertisement is to be displayed on the web page (Step 402). Advertisement generator 102 accesses merchant database 106 to retrieve an advertisement template for the advertisement user 110 wants to access (Step 404). Advertisement generator 102 accesses user database 104 to extract stylistic preferences of user 110 (Step 406). Advertisement generator 102 uses the extracted stylistic preferences to dynamically adjust the visual characteristics of the advertisement template and customize the advertisement specifically for user 110 (Step 408). The advertisement template is adjusted based on the extracted stylistic preferences to increase the probability of user 110 interacting with the advertisement. The customized advertisement is then displayed to user 110 (Step 410).

In some embodiments, machine learning model 212 generated by advertisement generator 102 may utilize different features with different weights to focus on certain features which may be more relevant to user 110. For example, user interaction or click through rate may increase almost linearly when user 110 is shown advertisements with reduced brightness. In another embodiment, user 110 may not interact when the displayed advertisement includes large background images and smaller fonts. In another embodiment, user 110 may interact with an advertisement including small background images. In another embodiment, advertisements with audio may generate more interactions than advertisements without audio. In another embodiment, advertisements with various colors may be less appealing to user 110 than advertisements with a prominent user preferred color.

In some embodiments, machine learning model 212 generated by advertisement generator 102 updates itself iteratively using the feedback from user 110 according to the manner in which user 110 interacts, or does not interact, with advertisements. For example, when user 110 is shown an advertisement with a prominent color (for example, red) and user 110 interacts with this advertisement, advertisement generator 102 assigns a positive value to this visual characteristic and stores this interaction as a stylistic preference of user 110. In another example, when user 110 is shown an advertisement with a prominent color (for example, grey) and user 110 does not interact with this advertisement, advertisement generator 102 assigns a negative value to this visual characteristic. In other words, advertisement generator 102 stores the color “red” as the stylistic preference of user 110 as opposed to the color “grey”.

In one embodiment, advertisement generator 102 is configured to generate feedback data to include information, such as a total number of clicks or interactions on an advertisement per amount of time (e.g., for all time, over one or more time periods, etc.) by a single user and by multiple users, a number of or interactions on an advertisement per user per amount of time, a number of “hits” for the advertisement during an amount of time for multiple users, a response rate (i.e., the number of users interacting in some way and making a purchase of an advertised product), a number of interactions or clicks (total or on a per-user basis) on the advertisement for one or more given device types (e.g., mobile devices, laptops, desktops, etc.), a number of interactions or clicks (total or on a per-user basis) on the advertisement for one or more distribution channels (e.g., e-mail, webpage, etc.), an amount of scrolling (e.g., performed on a webpage by a user), an amount of time an advertisement was visible on a display (total or on a per-user basis), or any other indicator of a degree of user interaction with the advertisement.

In some embodiments, advertisement generator 102 is configured to classify multiple users into different user groups. User groups may be based on stylistic preferences of the users. For example, all the users who interacted with advertisements displaying a red car or cars would be placed in one group and the users who interacted with advertisements displaying a blue car or cars would be placed in another group. In some embodiments, the manner in which advertisement generator 102 classifies users may be configured to collect user characteristic data for each group of users, extract stylistic preferences of the users belonging to the group and correlate the extracted stylistic preferences with the user characteristic data. User characteristic data may include demographic data including but not limited to age, gender, nationality, income, family size, marital status, occupation, religion, race, ethnicity, education, etc. User characteristic data may also include locations of users, time of the day when users are accessing webpages, time duration the users are spending on the webpages, types of device used by the users, etc.

In some embodiments, advertisement generator 102 may be configured to classify a new user 110 into a user group. Classifying may be executed by using an efficient multi-dimensional clustering algorithm to classify users into user groups. When a new user 110 accesses a webpage, advertisement generator 102 does not have sufficient information regarding stylistic preferences of new user 110. In this situation, advertisement generator 102 extracts user characteristic data. By taking into consideration the user characteristic data, new user 110 may be assigned to one or more of the user groups that share similar characteristic data. Based on stylistic preferences of the user group, an advertisement is customized for presentation to new user 110.

In some embodiments, based on interaction of new user 110 with the presented advertisement, advertisement generator 102 extracts user specific stylistic preferences. In some embodiments, the stylistic preferences of user 110 extracted in accordance with process 300 as discussed above, are used by machine learning model 212 to refine the stylistic preferences of new user 110 over a period of time.

While illustrative embodiments have been described herein, the scope thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified. Thus, the foregoing description has been presented for purposes of illustration only. It is not exhaustive and is not limited to the precise forms or embodiments disclosed. Modifications and adaptations will be apparent to those skilled in the art from consideration of the specification and practice of the disclosed embodiments.

The elements in the claims are to be interpreted broadly based on the language employed in the claims and not limited to examples described in the present specification or during the prosecution of the application, which examples are to be construed as non-exclusive. It is intended, therefore, that the specification and examples be considered as exemplary only, with a true scope and spirit being indicated by the following claims and their full scope of equivalents.

1. A system for customizing an advertisement to be displayed on a web page accessed by a user, the system comprising:
one or more memory devices storing instructions; and
one or more processors configured to execute the instructions to perform operations comprising:
detecting that the user has accessed the web page;
in response to detecting that the user has accessed the web page, retrieving, from a merchant database, an advertisement template for the advertisement, the merchant database storing a plurality of product-specific advertisement templates corresponding to a plurality of merchants;
generating, by a machine learning model, a plurality of stylistic preferences of the user based on prior interactions of the user with a plurality of online advertisements;
storing the stylistic preferences in a user database;
extracting a first one of the stylistic preferences from the user database, the first stylistic preference being an advertisement visual characteristic;
generating a customized advertisement by modifying a visual characteristic of the advertisement template based on the first stylistic preference; and
providing the customized advertisement for display to the user.

2. (canceled)

3. (canceled)

4. (canceled)

5. The system of claim 1, wherein the operations further comprise refining a plurality of the stylistic preferences extracted from the plurality of advertisements by the machine learning model.

6. The system of claim 1, wherein the stylistic preferences comprise at least one of font style, font size, image size, shape, dominant color, spacing, placement, or color.

7. (canceled)

8. The system of claim 5, wherein generating the customized advertisement comprises applying the extracted stylistic preferences to the advertisement template by the machine learning model.

9. A computer-implemented method for customizing an advertisement to be displayed on a web page accessed by a user, the method comprising:
detecting that the user has accessed the web page;
in response to detecting that the user has accessed the web page, retrieving, from a merchant database, an advertisement template for the advertisement, the merchant database storing a plurality of product-specific advertisement templates corresponding to a plurality of merchants;
learning a plurality of stylistic preferences of the user by a machine learning model, based on a positive feedback of prior interactions of the user with a plurality of online advertisements;
storing the stylistic preferences in a user database;
extracting a first one of the stylistic preferences from the user database, the first stylistic preference being an advertisement visual characteristic;
generating a customized advertisement by modifying a visual characteristic of the advertisement template based on the first extracted stylistic preference; and
providing the customized advertisement for display to the user.

10. (canceled)

11. (canceled)

12. (canceled)

13. The method of claim 9, further comprising refining a plurality of stylistic preferences extracted from the plurality of advertisements by the machine learning model.

14. The method of claim 9, wherein the stylistic preferences comprise at least one of font style, font size, image size, shape, dominant color, spacing, placement, or color.

15. (canceled)

16. The method of claim 14, wherein generating the customized advertisement comprises applying the extracted stylistic preferences to the advertisement template.

17. The method of claim 14, further comprising applying the stylistic preferences to one or more advertisements.

18. A non-transitory computer-readable medium storing instructions executable by one or more processors to perform operations for customizing an advertisement to be displayed on a web page accessed by a user, the operations comprising:
detecting that the user has accessed the web page;
in response to detecting that the user has accessed the web page; retrieving, from a merchant database, a product-specific advertisement template for the advertisement, the merchant database storing a plurality of product-specific advertisement templates corresponding to a plurality of merchants;
generating, by executing a machine learning model, a plurality of stylistic preferences of the user based on prior interactions of the user with a plurality of on line advertisements;
storing the stylistic preferences in a user database;
extracting a first one of the stylistic preferences from the user database, the first stylistic preference being an advertisement visual characteristic;
generating a customized advertisement by modifying a visual characteristic of the advertisement template based on the extracted stylistic preference; and
providing the customized advertisement for display to the user.

19. (canceled)

20. (canceled)

21. The system of claim 1, wherein the stylistic preferences comprise a percentage of the webpage covered by the advertisement.

22. The system of claim 1, wherein the stylistic preferences comprise a ratio of textual to pictorial representations within the advertisement.

23. The system of claim 1, wherein the stylistic preferences comprise a spatial arrangement of the advertisement on the webpage.

24. The method of claim 9, wherein generating a plurality of stylistic preferences of the user comprises determining that the user interacted with a first one of the advertisements.

25. The method of claim 24, wherein generating a plurality of stylistic preferences further comprises identifying, based on the determination, a plurality of visual characteristics of the first advertisement.

26. The method of claim 25, wherein the stylistic preferences comprise at least one of the visual characteristics of the first advertisement.

27. The method of claim 25, wherein generating a plurality of stylistic preferences further comprises:
determining that the user interacted with a second one of the advertisements; and
identifying, based on the determination that the user interacted with the second advertisement, a plurality of visual characteristics of the second advertisement.

28. The method of claim 27, wherein the stylistic preferences comprise at least one of the visual characteristics of the first advertisement and at least one of the visual characteristics of the second advertisement.

29. The method of claim 9, further comprising updating the machine learning model based on a degree of user interaction, the degree of user interaction comprising at least one of:
a number of interactions of the user with a first one of the plurality of the advertisements;
a number of interactions between a plurality of users with the first advertisement;
a response rate of the first advertisement;
a number of interactions on a distribution channel corresponding to the first advertisement; or
an amount of time the advertisement was visible to the user.
